(19) United States
(12) Patent Application Publication
(10) Pub. No.: US 2009/0118460 A1
(43) Pub. Date: May 7, 2009

(54) SOLUBLE AROMATIC RANDOM COPOLYIMIDE AND PROCESS FOR PREPARING SAME

(76) Inventors: Ravin NARAIN, Sudbury (CA); Bejoy Francis, Sudbury (CA); Keshwaree Babooran, Sudbury (CA)

Correspondence Address: STITES & HARBISON PLLC, 1199 NORTH FAIRFAX STREET, SUITE 900, ALEXANDRIA, VA, 22314, US

(21) Appl. No.: 11/936,465

(22) Filed: Nov. 7, 2007

(51) Int. Cl. C08G 73/10

(52) U.S. Cl. 528/328

(57) ABSTRACT

A soluble aromatic random copolyimide and a process for preparing same are herein disclosed, wherein the copolyimide is prepared from (a) an aromatic diamine and two or more different aromatic dianhydrides or (b) an aromatic dianhydride and two or more different aromatic diamines; wherein at least one of the diamine or the dianhydride contains a sulfonyl group directly or indirectly linking the two amine moieties in said diamine or the two anhydride moieties in said dianhydride. The copolyimide is soluble at room temperature in polar organic solvents such as N-methyl-2-pyrollidone, N,N-dimethylacetamide, and dimethylformamide, and has a glass transition temperatures below its respective melting points. As such, the copolyimide is more easily solubilized and processed into working forms, while still retaining desirable characteristics such as heat resistance, and may be used in various applications for which aromatic polyimides are known to be useful.

### FIELD OF INVENTION

The present invention relates to a soluble aromatic random copolyimide and a process for preparing said copolyimide.

### BACKGROUND OF THE INVENTION

Aromatic polyimides are a class of polymers used in a variety of high performance and/or high temperature applications. A general discussion of the preparation, characterization and applications of these compounds is found in Polyimides. Synthesis, Characterization and Applications, ed. K. L. Mittal, Plenum, N.Y., 1984. Polyimides are linear polymers synthesized by condensation polymerization of dianhydrides and diamines. In general, random polyimides can be synthesized from a single dianhydride and two or more diamines, or from a single diamine and two or more kinds of anhydrides.

Aromatic polyimides have a number of useful physical properties, such as very high tensile strength, high tensile modulus, very high resistance to wear, as well as chemical, heat and radiation resistance, and excellent dimensional stability. Such polyimides have a low coefficient of friction and are able to bond strongly with metals. Aromatic polyimides are also able to form films while still retaining the desirable physical properties noted above. For all of these reasons, aromatic polyimides are used extensively in the preparation of high performance materials and composites. Such applications include films, matrix resins for composites, adhesives, and coatings on components or machine parts that are subject to chemical, thermal, electrical and/or mechanical stress. Some examples of the wide-ranging uses of aromatic polyimides include: components used in jet engines and aerospace engineering; insulation in electrical motors and wiring; automotive parts; advanced textiles and membranes; fire barriers; thermal and acoustic insulation; seals in pumps and valves; and coatings to protect metals and other sensitive materials from wear and corrosion.

The useful properties of aromatic polyimides, such as solvent resistance, tensile strength and high temperature resistance, also render these compounds difficult to process into workable forms (e.g. films, coatings, sheets). Many aromatic polyimides are intractable due to high intermolecular forces, high polarity, and/or molecular stiffness and symmetry. This means that most polyimides are insoluble in commonly used organic solvents. Aromatic polyimides tend to be soluble only in halogenated organic solvents or upon heating in polar organic solvents with relatively high boiling points (typically greater than 100° C.), such as N-methyl-2-pyrrolidone (NMP), dimethylformamide (DMF) and N,N-dimethylacetamide (DMAc). Also, many of the totally aromatic polyimides have crystalline melting points are usually well above their thermal decomposition temperature, so that it is not possible to mold or reshape polyimides once formed.

In the past, workers have carried out the polymerization reaction in situ on a substrate (e.g. a machine component that is to be coated with the polyimide) or within a mold, in order to avoid the necessity for further processing. See for example, Meterko et al. in U.S. Pat. No. 5,171,828. By having to carry out the polymerization reaction in situ, this introduces additional problems to be overcome during the manufacturing process, such as having a substrate which is stable to the polymerization reaction conditions. Tamai et al. discloses a melt-processible polyimide in U.S. Pat. No. 5,268,446, in which the polyimide can be melted and formed into the required working shape. However, it would be advantageous to have a more tractable polyimide which is easily adaptable to a wide variety of manufacturing processes and conditions.

Attempts to increase the ease of handling and processability of aromatic polyimides involve the modification of the polymer backbone through monomer selection. Bulky substituents on the polymer backbone to enhance the free volume of the main chain and disrupt the symmetry of the polymer improve solubility and lower the melt viscosity of the polymer. Modifications include the incorporation of the following types of groups into the polymer backbone: aliphatic groups, polar and non-polar pendent substituents, heteroatoms (i.e. non-carbon atoms) or heterocyclic groups. For example, in U.S. Pat. No. 4,9643,649, Wright et al. disclosed a copolyimide comprising an aromatic sulfone and aromatic fluoroaliphatic groups.

Other methods to improve the handling ease of aromatic polyimides include the disruption of the symmetry of the polymer by either copolymerization with mixtures of two aromatic diamines or aromatic dianhydrides, or by forming a polymer from block segments of soluble oligomers which are themselves formed from flexible monomers. See for example, Bryant in U.S. Pat. No. 6,048,959.

Accordingly, there is a need for aromatic polyimides which retain desirable characteristics, such as tensile strength, temperature resistance, and solvent resistance, while being easily processible once formed. Preferably, such polyimides should be soluble in readily available organic solvents without requiring heating for solubilization to occur.

### SUMMARY OF THE INVENTION

In accordance with a broad aspect of the present invention there is provided a soluble aromatic random copolyimide wherein said copolyimide is a reaction product of:
(a) an aromatic sulfonyl diamine and two or more different aromatic dianhydrides;
(b) an aromatic dianhydride and two or more aromatic diamines, wherein at least one of the diamines contains a sulfonyl group directly or indirectly linking the two amine moieties of said diamine;
(c) an aromatic diamine and two or more different aromatic dianhydrides, wherein at least one of the dianhydrides contains a sulfonyl group directly or indirectly linking the two anhydride moieties of said dianhydride; or
(d) an aromatic sulfonyl dianhydride and two or more aromatic diamines.

In one embodiment, the copolyimide is prepared by reaction of an aromatic sulfonyl diamine and two or more different aromatic dianhydrides and has repeating units of formula (I):

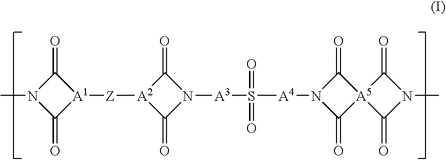

wherein:

A¹ and A² are trivalent aromatic radicals, A¹ and A² being same or different, each of A¹ and A² having 1 to 5 benzenoid-unsaturated rings of 6 carbon atoms wherein the two carbonyl groups bonded to each of A¹ and A² are directly bonded to adjacent carbon atoms in a benzene ring of each of A¹ and A²;

A³ and A⁴ are divalent aromatic radicals, A³ and A⁴ being same or different, each of A³ and A⁴ having 1 to 5 benzenoid-unsaturated rings of 6 carbon atoms, the nitrogen atom and the sulfonyl group bonded to each of A³ and A⁴ being directly bonded to different carbon atoms of a benzene ring in each of A³ and A⁴;

A⁵ is a tetravalent aromatic radical having 1 to 5 benzenoid-unsaturated rings of 6 carbon atoms wherein the four carbonyl groups bonded to A⁵ are directly bonded to different carbon atoms in a benzene ring of A⁵, each pair of carbonyl groups being bonded to adjacent carbon atoms in a benzene ring of A⁵; and

Z is a divalent chemical group or bond, selected from the group consisting of a carbonyl group

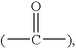

an oxy group (—O—), a sulfonyl group (—SO₂—) and a divalent C₁-C₆ alkyl group optionally substituted with one or more aryl groups of formula (II),

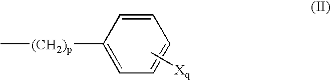

wherein p is an integer selected from 0 to 6, q is an integer selected from 0 to 5, wherein q is the total number of substituents X, and X is independently selected from the group consisting of halogen and C₁-C₆ branched or unbranched alkyl.

In one preferred embodiment, Z is selected from the group consisting of:

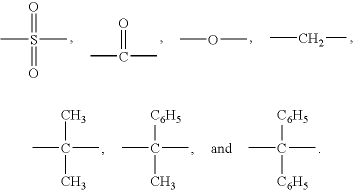

In another preferred embodiment, the aromatic sulfonyl diamine is selected from the group consisting of 4,4′-diaminodiphenylsulfone (DDS), 3,3′-diaminodiphenylsulfone, 1,7′-diaminodinaphthylsulfone, 1,6′-diaminodinaphthylsulfone, bis[4-(4-aminophenoxy)phenyl]sulfone, bis[4-(3-aminophenoxy)phenyl]sulfone, bis(4-aminobenzophenone)sulfone, bis(3-aminobenzophenone)sulfone, and bis[2,2,-(4-aminophenyl-4-phenyl-4-phenyl)propane]sulfone. Preferably, each of said dianhydrides is selected from the group consisting of pyromellitic dianhydride (PMDA), 3,3′,4,4′-benzophenonetetracarboxylic dianhydride (BTDA), 2,3,3′,4′-benzophenonetetracarboxylic dianhydride, 2,2′,3,3′-benzophenonetetracarboxylic dianhydride, 4,4′,5,5′,6,6′-hexafluorobenzophenone-2,2′,3,3′-tetracarboxylic dianhydride, 3,3′,4,4′-diphenyl-tetracarboxylic dianhydride, 2,2′,3,3′-diphenyltetracarboxylic dianhydride, bis(3,4-dicarboxyphenyl)sulphone dianhydride, bis(2,5,6-trifluoro-3,4-dicarboxyphenyl)sulphone dianhydride, bis(3,4-dicarboxyphenyl)phenylphosphonate dianhydride, bis(3,4-dicarboxyphenyl)phenylphosphine oxide dianhydride, N,N-(3,4-dicarboxyphenyl)-N-methylamine dianhydride, bis(3,4-dicarboxyphenyl)diethylsilane dianhydride, 1,4,5,8-naphthalenetetracarboxylic dianhydride, 2,3,6,7-naphthalenetetracarboxylic dianhydride, 1,2,5,6-naphthalenetetracarboxylic dianhydride. 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, 1,4,5,8-tetrafluoronaphthalene-2,3,6,7-tetracarboxylic dianhydride, and phenanthrene-1,8,9,10-tetracarboxylic dianhydride.

In yet another embodiment, there is provided a soluble aromatic random copolyimide having repeating units of formula (III):

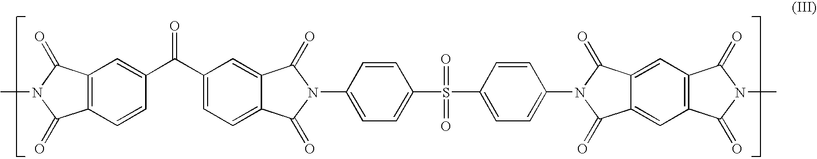

The copolyimide of formula (III) can be prepared by reaction of 4,4′-diaminodiphenylsulfone (DDS) with pyromellitic dianhydride (PMDA) and 3,3′,4,4′-benzophenonetetracarboxylic dianhydride (BTDA).

The copolyimide is soluble in an organic solvent with optional heating. The organic solvent is preferably a polar organic solvent. Preferred polar organic solvents are selected from the group consisting of m-cresol, N-methyl-2-pyrollidone (NMP), dimethyl sulfoxide (DMSO), N,N-dimethylacetamide (DMAc), and dimethylformamide (DMF).

In another embodiment, the copolyimide has a glass transition temperature of about 310° C. to about 350° C.

Another aspect of the present invention includes a composite material comprising the above-noted soluble aromatic random copolyimide.

In another broad aspect of the present invention, there is provided a process for preparing a soluble aromatic random copolyimide, the process comprising:
(i) forming a polyamic acid intermediate from (a) an aromatic sulfonyl diamine and two or more different aromatic dianhydrides; (b) an aromatic dianhydride and two or more aromatic diamines, wherein at least one of the diamines contains a sulfonyl group directly or indirectly linking the two amine moieties of said diamine; (c) an aromatic diamine and two or more different aromatic dianhydrides, wherein at least one of the dianhydrides contains a sulfonyl group directly or indirectly linking the two anhydride moieties of said dianhydride; or (d) an aromatic sulfonyl dianhydride and two or more aromatic diamines; and
(ii) thermally or chemically imidizing the polyamic acid intermediate to form said copolyimide.

In a preferred embodiment of the process, wherein the copolyimide is prepared from the combination (a) noted above, the aromatic sulfonyl diamine is reacted sequentially with two different aromatic dianhydrides to form a polyamic acid intermediate. Preferably, the sterically bulkier dianhydride of said two dianhydrides is reacted with said diamine first.

The aromatic copolyimide disclosed herein has improved processability as compared to known aromatic polyimides, and is readily soluble in common organic solvents at room temperature, i.e. generally without heating, and its glass transition temperature (T_{g}) is lower than its respective melting temperature (Tₘ). Thus, the copolyimide of the invention may be easily handled by solubilizing in an organic solvent. The copolyimide of the invention also has enhanced film-forming and molding properties, as compared to known aromatic polymides, due to its lowered glass transition temperatures. The copolyimide of the invention also demonstrates good heat resistance, which is desirable for use in high performance materials. As such, the copolyimide of the invention retains the useful characteristics of the broader class of aromatic polyimides while being more easily processed than known aromatic polyimides.

A further advantage of the present invention is providing a simple process for preparing copolyimides with greater solubility in common organic solvents.

Other and further advantages and features of the invention will be apparent to those skilled in the art from the following detailed description of an embodiment thereof, taken in conjunction with the accompanying drawings.

### BRIEF DESCRIPTION OF THE DRAWINGS

The present invention will be further understood from the following detailed description of an embodiment of the invention, with reference to the drawings in which:

FIG. 1(a) illustrates a general reaction scheme for the synthesis of a soluble random aromatic copolyimide from an aromatic sulfonyl diamine and two different aromatic dianhydrides, in accordance with a broad aspect of the present invention;

FIG. 1(b) illustrates the reaction scheme for the synthesis of a soluble random aromatic copolyimide from diaminodiphenyl sulfone (DDS), and two different dianhydrides, 3,3′,4,4′-benzophenone tetracarboxylic dianhydride (BTDA), and pyromellitic dianhydride (PMDA), in accordance with a preferred embodiment of the present invention;

FIG. 2 illustrates the Fourier transform infrared (FTIR) spectra of three soluble random aromatic copolyimides, CPI-1, CPI-2, and CPI-3, prepared in accordance with an embodiment of the present invention;

FIG. 3 illustrates the ¹H nuclear magnetic resonance (NMR) spectrum for a copolyimide of the present invention, CPI-2, prepared according to Example 3;

FIG. 4 illustrates the ¹³C NMR spectrum for a copolyimide of the present invention, CPI-2;

FIG. 5 illustrates the ultraviolet (UV) spectra of three copolyimides of the present invention, CPI-1, CPI-2 and CPI-3;

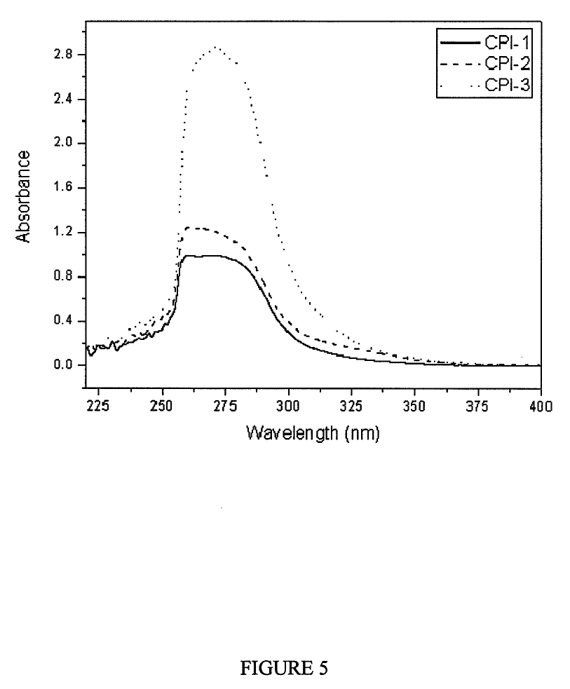

FIG. 6 illustrates the differential scanning calorimetry (DSC) thermogram of a copolyimide of the present invention, CPI-2; and

FIG. 7 illustrates the thermogravimetric analysis (TGA) curve of a copolyimide of the present invention, CPI-2.

### DETAILED DESCRIPTION OF THE INVENTION

In a preferred embodiment of the present invention, there is provided a soluble aromatic random copolyimide prepared from the polymerization reaction of an aromatic sulfonyl diamine and two or more different aromatic dianhydrides.

The term “soluble”, as used herein means soluble in organic solvents, preferably polar organic solvents including m-cresol, and particularly polar aprotic solvents including N-methyl-2-pyrollidone (NMP), dimethyl sulfoxide (DMSO), N,N-dimethylacetamide (DMAc), and dimethylformamide (DMF).

Preferably, the copolyimide of the invention is soluble in the organic solvent at room temperature, i.e. heating is optional and not required for solubilizing the copolymide.

In a preferred embodiment, the aromatic copolyimide has the general formula (I),

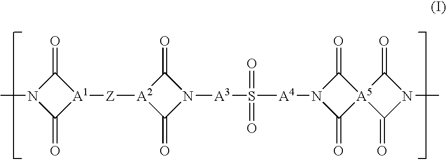

wherein:

A¹ and A² are trivalent aromatic radicals, A¹ and A² being same or different, each of A¹ and A² having 1 to 5 benzenoid-unsaturated rings of 6 carbon atoms wherein the two carbonyl groups bonded to each of A¹ and A² are directly bonded to adjacent carbon atoms in a benzene ring of each of A¹ and A²;

A³ and A⁴ are divalent aromatic radicals, A³ and A⁴ being same or different, each of A³ and A⁴ having 1 to 5 benzenoid-unsaturated rings of 6 carbon atoms, the nitrogen atom and the sulfonyl group bonded to each of A³ and A⁴ being directly bonded to different carbon atoms of a benzene ring in each of A³ and A⁴;

A⁵ is a tetravalent aromatic radical having 1 to 5 benzenoid-unsaturated rings of 6 carbon atoms wherein the four carbonyl groups bonded to A⁵ are directly bonded to different carbon atoms in a benzene ring of A⁵, each pair of carbonyl groups being bonded to adjacent carbon atoms in a benzene ring of A⁵; and

Z is a divalent chemical group or bond, selected from the group consisting of a carbonyl group

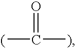

an oxy group (—O—), a sulfonyl group (—SO₂—) and a divalent C₁-C₆ alkyl group optionally substituted with one or more aryl groups of formula (II),

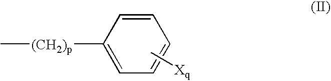

wherein p is an integer selected from 0 to 6, q is an integer selected from 0 to 5, wherein q is the total number of substituents X, and X is independently selected from the group consisting of halogen and C₁-C₆ branched or unbranched alkyl.

Illustrative examples of Z that are preferred are:

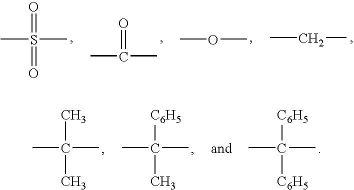

In yet another preferred embodiment, Z is a carbonyl group

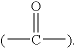

Without being limited to the following list, illustrative examples of aromatic sulfonyl diamines that are preferred for use in the methods disclosed herein are 4,4′-diaminodiphenylsulfone, 3,3′-diaminodiphenylsulfone, 1,7′-diaminodinaphthylsulfone, 1,6′-diaminodinaphthylsulfone, bis[4-(4-aminophenoxy)phenyl]sulfone, bis[4-(3-aminophenoxy)phenyl]sulfone, bis(4-aminobenzophenone)sulfone, bis(3-aminobenzophenone)sulfone, bis[2,2,-(4-aminophenyl-4-phenyl-4-phenyl)propane]sulfone and obvious chemical equivalents thereof.

Without being limited to the following, illustrative examples of aromatic dianhydrides which are suitable for use in preparing the polyimide according to the methods disclosed herein are: pyromellitic dianhydride (PMDA), 3,3′,4,4′-benzophenonetetracarboxylic dianhydride (BTDA), 2,3,3′,4′-benzophenonetetracarboxylic dianhydride, 2,2′,3,3′-benzophenonetetracarboxylic dianhydride, 4,4′,5,5′,6,6′-hexafluorobenzophenone-2,2′,3,3′-tetracarboxylic dianhydride, 3,3′,4,4′-diphenyl-tetracarboxylic dianhydride, 2,2′,3,3′-diphenyltetracarboxylic dianhydride, bis(3,4-dicarboxyphenyl)sulphone dianhydride, bis(2,5,6-trifluoro-3,4-dicarboxyphenyl)sulphone dianhydride, bis(3,4-dicarboxyphenyl)phenylphosphonate dianhydride, bis(3,4-dicarboxyphenyl)phenylphosphine oxide dianhydride, N,N-(3,4-dicarboxyphenyl)-N-methylamine dianhydride, bis(3,4-dicarboxyphenyl)diethylsilane dianhydride, 1,4,5,8-naphthalenetetracarboxylic dianhydride, 2,3,6,7-naphthalenetetracarboxylic dianhydride, 1,2,5,6-naphthalenetetracarboxylic dianhydride. 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, 1,4,5,8-tetrafluoronaphthalene-2,3,6,7-tetracarboxylic dianhydride, and phenanthrene-1,8,9,10-tetracarboxylic dianhydride and obvious chemical equivalents thereof.

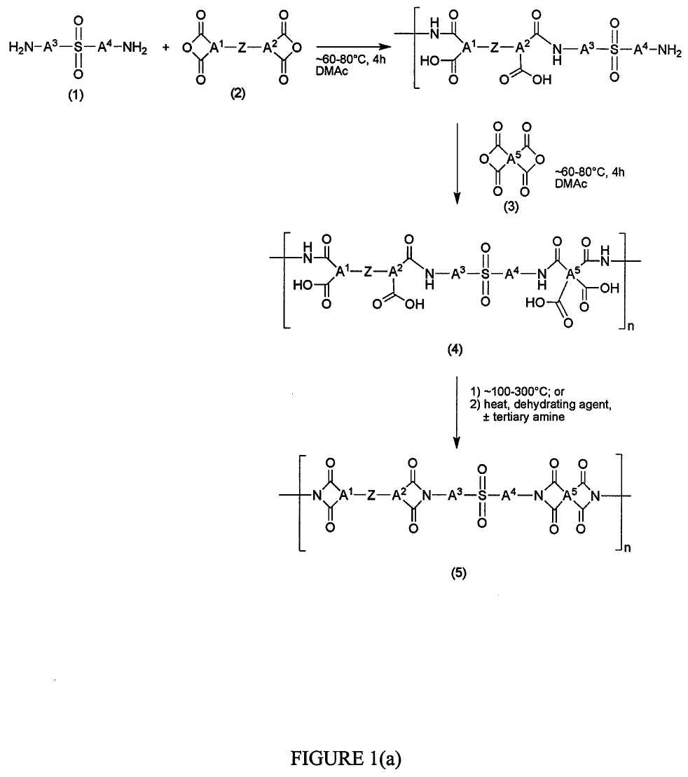

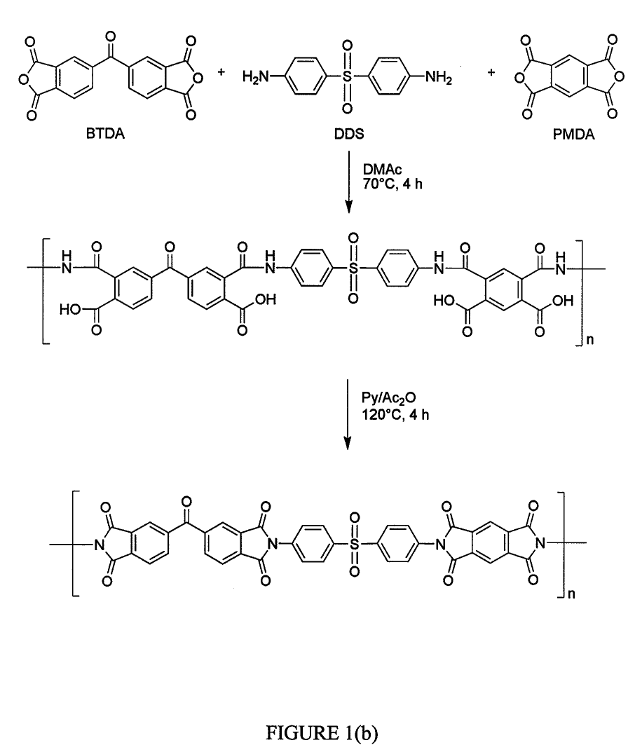

Referring to FIG. 1(a), in the first step of the polymerization reaction, the aromatic sulfonyl diamine (1) is reacted sequentially with two different aromatic dianhydrides (2, 3) to form a polyamic acid intermediate (4). The dianhydrides (2, 3) shown in FIG. 1(a) may be added in any order, however preferably, the sterically bulkier dianhydride (2) of the two different anhydrides is added first in order to control the rate of reaction in the first stage of polymerization. Next, the cyclization of the polyamic acid (4) to the corresponding polyimide (5) (where “n” is a positive integer greater than or equal to 1) is carried out by heating the polyamic acid to temperatures between about 100° C. and 300° C., or by heating with a dehydrating agent by itself or in combination with a tertiary amine (e.g. triethylamine or pyridine).

Preferred solvents for the polymerization reaction are polar aprotic solvents such as N,N-dimethylacetamide (as shown in FIG. 1(a)), N,N-diethylacetamide, N,N-dimethylformamide and N-methyl-2-pyrrolidone and obvious chemical equivalents thereof. After completion of the polymerization reaction, the solvent can be removed by filtration and drying in vacuo.

Examples of preferred dehydrating agents are acetic anhydride, propionic anhydride and dicyclohexylcarbodiimide, optionally with a tertiary amine and obvious chemical equivalents thereof. A preferred dehydrating agent is a mixture of acetic anhydride and triethylamine or pyridine. In yet another preferred embodiment, the cyclisation was done by heating the polyamic acid between 100° C. and 130° C. and using a mixture of acetic anhydride and pyridine.

The copolyimides of the invention may be used in alone or in the preparation of composite materials. The copolyimides and composite materials comprising the copolyimides can be used in high performance materials and other applications for which aromatic polyimides are known to be useful. For example, the copolyimides can be compounded with silicon dioxide or other silicon materials to form silicon composites. Due to their enhanced processability, the copolyimides of the invention can be readily formed into laminates and films.

Further details of preferred embodiment of the invention are illustrated in the following Examples which are understood to be non-limiting with respect to the appended claims.

### EXAMPLE 1

The following series of reactions are as provided in the reaction scheme of FIG. 1(b). Abbreviations used in FIG. 1(b) are as defined below.

In a 50 mL three necked round bottom flask equipped with dry nitrogen inlet, outlet and a condenser was added 0.4966 g (2 mmol) 4,4′-diaminodiphenyl sulfone (DDS) and 3 mL N,N-dimethylacetamide (DMAc). The diamine, DDS, was dissolved in the solvent, DMAc, and 0.1288 g (0.4 mmol) 3,3′,4,4′-benzophenone tetracarboxylic dianhydride (BTDA) was added and stirred. The reaction mixture was heated to between 60° C. and 80° C. for about 4 h. After the mentioned time, 0.3496 g (1.6 mmol) pyromellitic dianhydride (PMDA) and 2 mL DMAc was added and the reaction was continued for about 4 h. The molar ratio of BTDA:DDS:PMDA was 0.2:1:0.8. In FIG. 1(b), “n” is a positive integer greater than or equal to 1.

The mixture was stirred at room temperature overnight, after which the temperature of the reaction mixture was raised to about 100 to 130° C. About 0.5 mL pyridine (Py) and about 1 mL acetic anhydride (Ac₂O) was added to the reaction mixture and stirred for about 2 to 3 h. The copolyimide precipitated out slowly. The precipitated polymer was washed with acetone and with water and filtered. The polymer was dried under vacuum at about 120° C. for 8 h. The copolyimide was found to have a glass transition temperature (T_{g}) of about 335° C.

### EXAMPLE 2

The procedure for Example 1 was followed to prepare the following copolyimide, entitled “CPI-1”. 0.2577 g (0.8 mmol) 3,3′,4,4′-benzophenone tetracarboxylic dianhydride (BTDA) and 0.2614 g (1.2 mmol) pyromellitic dianhydride (PMDA) was used for the synthesis of the copolyimide CPI-1. The molar ratio of BTDA:DDS:PMDA was 0.4:1:0.6. The resultant copolyimide CPI-1 was found to have a glass transition temperature (T_{g}) of about 330° C.

### EXAMPLE 3

The procedure for Example 1 was followed to prepare the following copolyimide, entitled “CPI-2”. 0 3222 g (1.0 mmol) 3,3′,4,4′-benzophenone tetracarboxylic dianhydride (BTDA) and 0.2181 g (1.0 mmol) pyromellitic anhydride (PMDA) was used for the synthesis of the copolyimide CPI-2. The molar ratio of BTDA:DDS:PMDA was 0.5:1:0.5. The copolyimide CPI-2 was found to have a glass transition temperature (T_{g}) of about 325° C.

### EXAMPLE 4

The procedure for Example 1 was followed to prepare the following copolyimide, entitled “CPI-3”. 0.3864 g (1.2 mmol) 3,3′,4,4′-benzophenone tetracarboxylic dianhydride (BTDA) and 0.1745 g (0.8 mmol) pyromellitic dianhydride (PMDA) was used for the synthesis of the copolyimide CPI-3. The molar ratio of BTDA:DDS:PMDA was 0.6:1:0.4. The copolyimide CPI-3 was found to have a glass transition temperature (T_{g}) of about 325° C.

### EXAMPLE 5

The procedure for Example 1 was followed to prepare the following copolyimide. 0.5155 g (1.6 mmol) 3,3′,4,4′-benzophenone tetracarboxylic dianhydride (BTDA) and 0.0872 g (0.4 mmol) pyromellitic anhydride (PMDA) was used for the synthesis of the copolymer. The molar ratio of BTDA:DDS:PMDA was 0.8:1:0.2. The copolyimide was found to have a glass transition temperature (T_{g}) of about 310° C.

### EXAMPLE 6

The copolyimides of Examples 2, 3 and 4, i.e. CPI-1, CPI-2 and CPI-3, respectively, were tested for their solubility in a number of common organic solvents: N-methyl-2-pyrollidone (NMP), dimethyl sulfoxide (DMSO), m-cresol, N,N-dimethylacetamide (DMAc), and dimethylformamide (DMF). The solubility results are summarized in Table 1 below.

TABLE 1

| Copol- | | | | m- | | |
|---|---|---|---|---|---|---|
| ymer | BTDA:DDS:PMDA | NMP | DMSO | cresol | DMAc | DMF |
| CPI-1 | 0.4:1:0.6 | + | + | + | + | ± |
| CPI-2 | 0.5:1:0.5 | + | + | + | + | + |
| CPI-3 | 0.6:1:0.4 | + | + | + | + | + |

+ soluble at room temperature
± soluble on heating

As can be seen in Table 1, CPI-2 and CPI-3 were soluble in NMP, DMSO, m-cresol, DMAC and DMF at room temperature. CPI-1 was soluble in NMP, DMSO, m-cresol and DMAc at room temperature, but required heating to dissolve in DMF.

The weight average molecular weight (M_{w}), the number average molecular weight (Mₙ), and the polydispersity index (M_{w}/Mₙ) were determined for each of copolyimides CPI-1, CPI-2, and CPI-3, and are summarized in Table 2 below.

TABLE 2

| Copolyimide | BTDA:DDS:PMDA | Mₙ (g/mol) | M_{w} (g/mol) | M_{w}/Mₙ |
|---|---|---|---|---|
| CPI-1 | 0.4:1:0.6 | 191466 | 1.421 × 10⁶ | 7.42 |
| | | 5096 | 7061 | 1.39 |
| CPI-2 | 0.5:1:0.5 | 170881 | 1.531 × 10⁶ | 8.96 |
| | | 5316 | 7161 | 1.35 |
| CPI-3 | 0.6:1:0.4 | 785604 | 3.814 × 10⁶ | 4.85 |
| | | 5488 | 7987 | 1.46 |

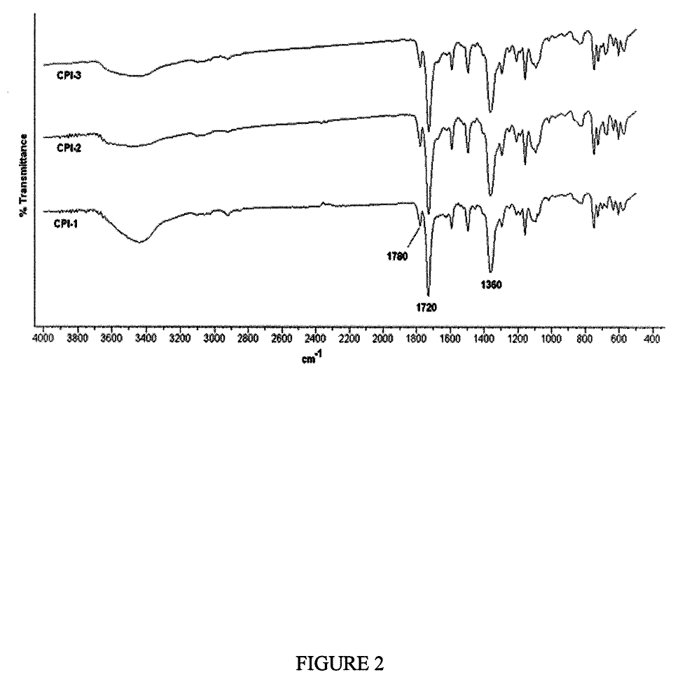

The FTIR spectrum of each of CPI-1, CPI-2 and CPI-3 is provided in FIG. 2. The spectrum for each of CPI-1, CPI-2 and CPI-3 showed peaks at 1780 and 1720 cm⁻¹, corresponding to the asymmetrical and symmetrical C═O imide stretching vibration. The peak at 1360 cm⁻¹ corresponds to C—N stretching vibrations of the imide ring within the copolyimide.

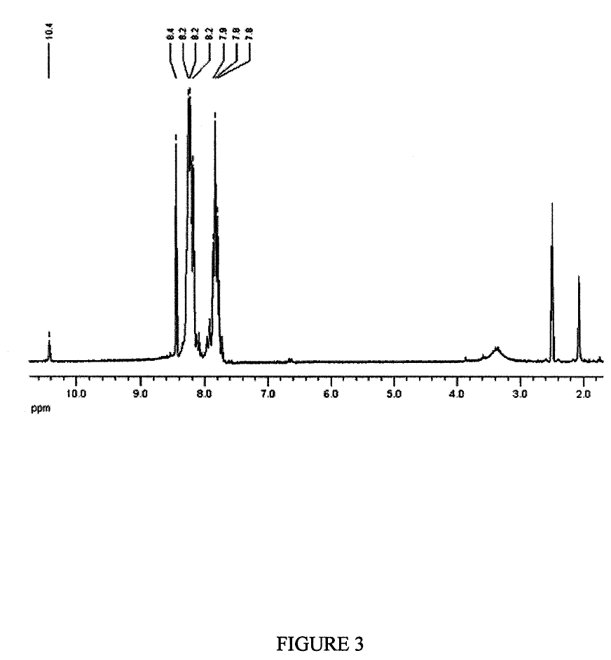

The UV spectrum of each of CPI-1, CPI-2 and CPI-3 is provided in FIG. 3. The spectrum for each of CPI-1, CPI-2 and CPI-3 showed a peak between 250 to 325 nm, which is due to the carbonyl group and aromatic rings within the copolyimide.

CPI-2 was further analyzed by ¹H NMR, ¹³C NMR, differential scanning calorimetry (DSC) and thermogravimetric anaylsis (TGA).

The ¹H NMR spectrum of CPI-2 is shown in FIG. 3. Referring to FIG. 3, there are peaks observed between 7.6 and 8.4 ppm that are due to the aromatic protons. The peak at 8.4 ppm is due to the protons of PMDA in CPI-2.

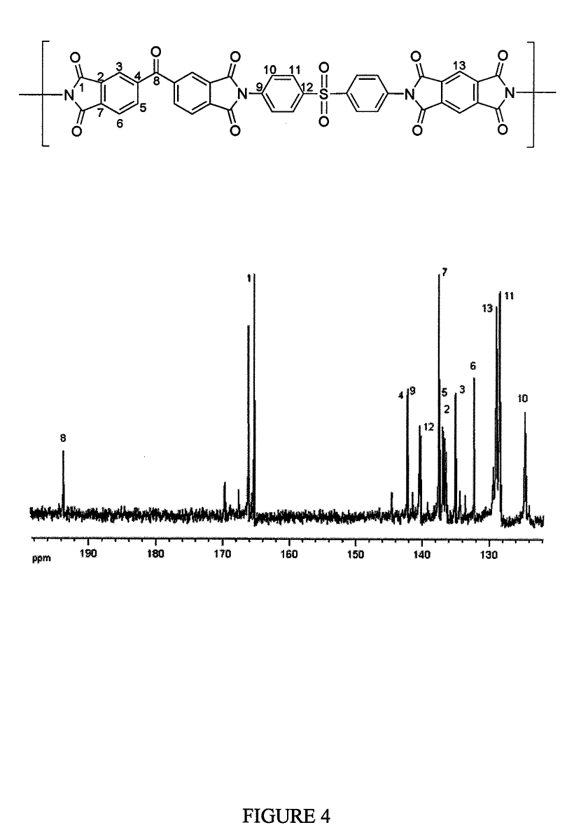

The ¹³C NMR spectrum of CPI-2 is shown in FIG. 4. Referring to FIG. 4, there is a peak observed at 191.5 ppm, which is due to the carbonyl carbon within CPI-2. The remaining peaks in the ¹³C NMR spectrum of CPI-2 correspond to the carbon atoms of the aromatic rings within CPI-2.

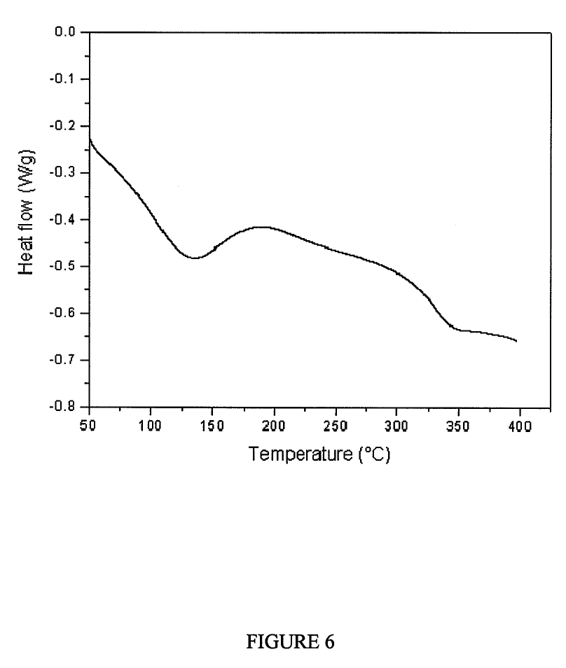

The DSC curve for CPI-2 is shown in FIG. 6. As shown in the DSC curve for CPI-2, the T_{g} is around 325° C.

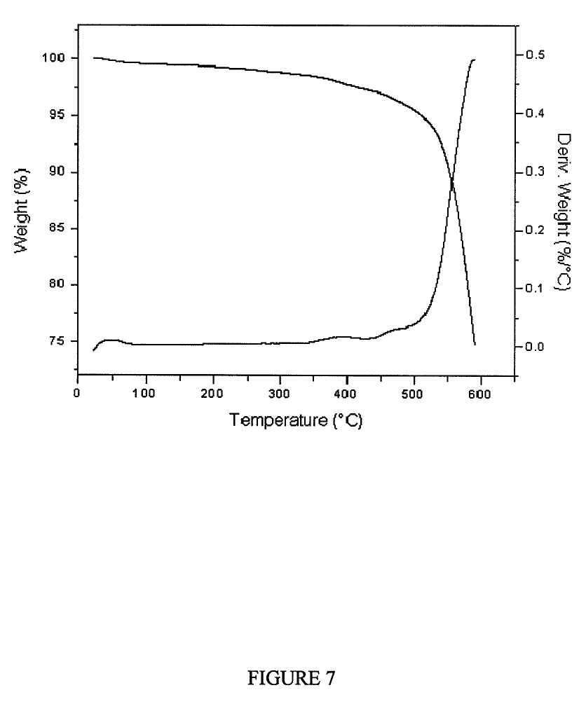

The TGA curve for CPI-2 is shown in FIG. 7. Significant degradation does not occur in CPI-2 until temperatures above around 500° C. As such, CPI-2 shows very good heat resistance, which is a desirable characteristic and very useful in many high performance applications.

Numerous modifications, variations, adaptations may be made to the particular embodiments of the invention described above without departing form the scope of the invention, which is defined in the following claims.

We claim:

1. A soluble aromatic random copolyimide wherein said copolyimide is a reaction product of:
(a) an aromatic sulfonyl diamine and two or more different aromatic dianhydrides;
(b) an aromatic dianhydride and two or more aromatic diamines, wherein at least one of the diamines contains a sulfonyl group directly or indirectly linking the two amine moieties of said diamine;
(c) an aromatic diamine and two or more different aromatic dianhydrides, wherein at least one of the dianhydrides contains a sulfonyl group directly or indirectly linking the two anhydride moieties of said dianhydride; or
(d) an aromatic sulfonyl dianhydride and two or more aromatic diamines.

2. The copolyimide of claim 1(a), having repeating units of formula (I), 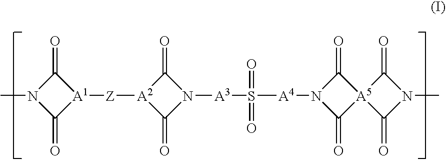
wherein:
A¹ and A² are trivalent aromatic radicals, A¹ and A² being same or different, each of A¹ and A² having 1 to 5 benzenoid-unsaturated rings of 6 carbon atoms wherein the two carbonyl groups bonded to each of A¹ and A² are directly bonded to adjacent carbon atoms in a benzene ring of each of A¹ and A²;
A³ and A⁴ are divalent aromatic radicals, A³ and A⁴ being same or different, each of A³ and A⁴ having 1 to 5 benzenoid-unsaturated rings of 6 carbon atoms, the nitrogen atom and the sulfonyl group bonded to each of A³ and A⁴ being directly bonded to different carbon atoms of a benzene ring in each of A³ and A⁴;
A⁵ is a tetravalent aromatic radical having 1 to 5 benzenoid-unsaturated rings of 6 carbon atoms wherein the four carbonyl groups bonded to A⁵ are directly bonded to different carbon atoms in a benzene ring of A⁵, each pair of carbonyl groups being bonded to adjacent carbon atoms in a benzene ring of A⁵; and
Z is a divalent chemical group or bond, selected from the group consisting of a carbonyl group 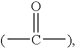
an oxy group (—O—), a sulfonyl group (—SO₂—) and a divalent C₁-C₆ alkyl group optionally substituted with one or more aryl groups of formula (II), 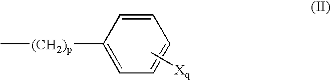
wherein p is an integer selected from 0 to 6, q is an integer selected from 0 to 5, wherein q is the total number of substituents X, and X is independently selected from the group consisting of halogen and C₁-C₆ branched or unbranched alkyl.

3. The copolyimide of claim 2, wherein Z is selected from the group consisting of:

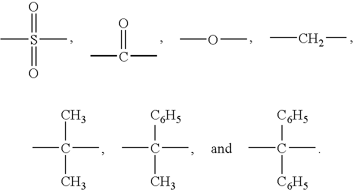

4. The copolyimide of claim 1 (a), wherein said aromatic sulfonyl diamine is selected from the group consisting of
4,4′-diaminodiphenylsulfone (DDS), 3,3′-diaminodiphenylsulfone, 1,7′-diaminodinaphthylsulfone, 1,6′-diaminodinaphthylsulfone, bis[4-(4-aminophenoxy)phenyl]sulfone, bis[4-(3-aminophenoxy)phenyl]sulfone, bis(4-aminobenzophenone)sulfone, bis(3-aminobenzophenone)sulfone, and bis[2,2,-(4-aminophenyl-4-phenyl-4-phenyl)propane]sulfone;
and each of said dianhydrides is selected from the group consisting of
pyromellitic dianhydride (PMDA), 3,3′,4,4′-benzophenonetetracarboxylic dianhydride (BTDA), 2,3,3′,4′-benzophenonetetracarboxylic dianhydride, 2,2′,3,3′-benzophenonetetracarboxylic dianhydride, 4,4′,5,5′,6,6′-hexafluorobenzophenone-2,2′,3,3′-tetracarboxylic dianhydride, 3,3′,4,4′-diphenyl-tetracarboxylic dianhydride, 2,2′,3,3′-diphenyltetracarboxylic dianhydride, bis(3,4-dicarboxyphenyl)sulphone dianhydride, bis(2,5,6-trifluoro-3,4-dicarboxyphenyl)sulphone dianhydride, bis(3,4-dicarboxyphenyl)phenylphosphonate dianhydride, bis(3,4-dicarboxyphenyl)phenylphosphine oxide dianhydride, N,N-(3,4-dicarboxyphenyl)-N-methylamine dianhydride, bis(3,4-dicarboxyphenyl)diethylsilane dianhydride, 1,4,5,8-naphthalenetetracarboxylic dianhydride, 2,3,6,7-naphthalenetetracarboxylic dianhydride, 1,2,5,6-naphthalenetetracarboxylic dianhydride. 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, 1,4,5,8-tetrafluoronaphthalene-2,3,6,7-tetracarboxylic dianhydride, and phenanthrene-1,8,9,10-tetracarboxylic dianhydride.

5. The copolyimide of claim 2 having repeating units of formula (III):

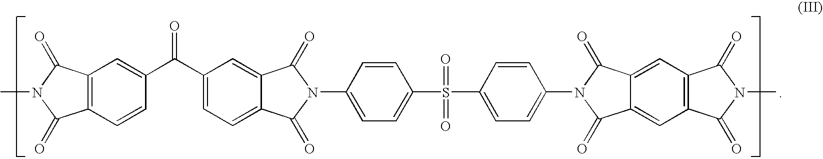

6. The copolyimide of claim 1 wherein said copolyimide is soluble in a polar organic solvent with optional heating.

7. The copolyimide of claim 6 wherein said organic solvent is selected from the group consisting of m-cresol, N-methyl-2-pyrollidone (NMP), dimethyl sulfoxide (DMSO), N,N-dimethylacetamide (DMAc), and dimethylformamide (DMF).

8. The copolyimide of claim 1 wherein said copolyimide has a glass transition temperature of about 310° C. to about 350° C.

9. A composite material comprising the copolyimide of claim 1.

10. A process for preparing a soluble aromatic random copolyimide, the process comprising:
(i) forming a polyamic acid intermediate from (a) an aromatic sulfonyl diamine with two or more different aromatic dianhydrides; or (b) an aromatic dianhydride and two or more aromatic diamines, wherein at least one of the diamines contains a sulfonyl group directly or indirectly linking the two amine moieties of said diamine; (c) an aromatic diamine and two or more different aromatic dianhydrides, wherein at least one of the dianhydrides contains a sulfonyl group directly or indirectly linking the two anhydride moieties of said dianhydride; or (d) an aromatic sulfonyl dianhydride and two or more aromatic diamines; and
(ii) thermally or chemically imidizing the polyamic acid intermediate to form said copolyimide.

11. The process according to claim 10, part (i)(a), wherein said aromatic sulfonyl diamine is reacted sequentially with two different aromatic dianhydrides to form a polyamic acid intermediate.

12. The process of claim 11 wherein the sterically bulkier dianhydride of said two dianhydrides is reacted with said diamine first.

13. The process of claim 11 wherein said copolyimide has repeating units of formula (I): 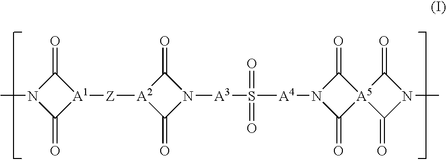
and wherein said aromatic sulfonyl diamine is of formula (IV): 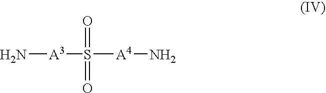
and said dianhydrides are of formulas (V) and (VI): 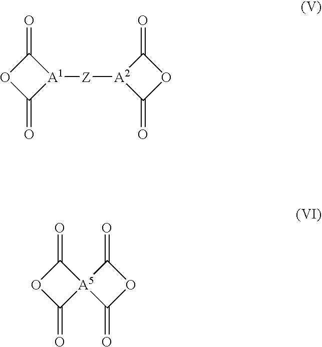
wherein;
A¹ and A² are trivalent aromatic radicals, A¹ and A² being same or different, each of A¹ and A² having 1 to 5 benzenoid-unsaturated rings of 6 carbon atoms wherein the two carbonyl groups bonded to each of A¹ and A² are directly bonded to adjacent carbon atoms in a benzene ring of each of A¹ and A²;
A³ and A⁴ are divalent aromatic radicals, A³ and A⁴ being same or different, each of A³ and A⁴ having 1 to 5 benzenoid-unsaturated rings of 6 carbon atoms, the nitrogen atom and the sulfonyl group bonded to each of A³ and A⁴ being directly bonded to different carbon atoms of a benzene ring in each of A³ and A⁴;
A⁵ is a tetravalent aromatic radical having 1 to 5 benzenoid-unsaturated rings of 6 carbon atoms wherein the four carbonyl groups bonded to A⁵ are directly bonded to different carbon atoms in a benzene ring of A⁵, each pair of carbonyl groups being bonded to adjacent carbon atoms in a benzene ring of A⁵; and
Z is a divalent chemical group or bond, selected from the group consisting of a carbonyl group 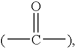
an oxy group (—O—), a sulfonyl group (—SO₂—) and a divalent C₁-C₆ alkyl group optionally substituted with one or more aryl groups of formula (II), 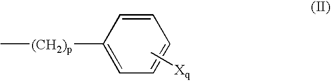
wherein p is an integer selected from 0 to 6, q is an integer selected from 0 to 5, wherein q is the total number of substituents X, and X is independently selected from the group consisting of halogen and C₁-C₆ branched or unbranched alkyl.

14. The process of claim 13 wherein Z is selected from the group consisting of:

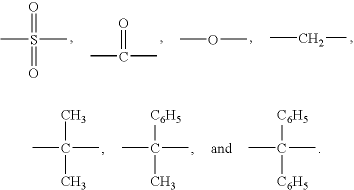

15. The process of claim 13 wherein the aromatic sulfonyl diamine is selected from the group consisting of
4,4′-diaminodiphenylsulfone (DDS), 3,3′-diaminodiphenylsulfone, 1,7′-diaminodinaphthylsulfone, 1,6′-diaminodinaphthylsulfone, bis[4-(4-aminophenoxy)phenyl]sulfone, bis[4-(3-aminophenoxy)phenyl]sulfone, bis(4-aminobenzophenone)sulfone, bis(3-aminobenzophenone)sulfone, and bis[2,2,-(4-aminophenyl-4-phenyl-4-phenyl)propane]sulfone;
and each of said dianhydrides is selected from the group consisting of
pyromellitic dianhydride (PMDA), 3,3′,4,4′-benzophenonetetracarboxylic dianhydride (BTDA), 2,3,3′,4′-benzophenonetetracarboxylic dianhydride, 2,2′,3,3′-benzophenonetetracarboxylic dianhydride, 4,4′,5,5′,6,6′-hexafluorobenzophenone-2,2′,3,3′-tetracarboxylic dianhydride, 3,3′,4,4′-diphenyl-tetracarboxylic dianhydride, 2,2′,3,3′-diphenyltetracarboxylic dianhydride, bis(3,4-dicarboxyphenyl)sulphone dianhydride, bis(2,5,6-trifluoro-3,4-dicarboxyphenyl)sulphone dianhydride, bis(3,4-dicarboxyphenyl)phenylphosphonate dianhydride, bis(3,4-dicarboxyphenyl)phenylphosphine oxide dianhydride, N,N-(3,4-dicarboxyphenyl)-N-methylamine dianhydride, bis(3,4-dicarboxyphenyl)diethylsilane dianhydride, 1,4,5,8-naphthalenetetracarboxylic dianhydride, 2,3,6,7-naphthalenetetracarboxylic dianhydride, 1,2,5,6-naphthalenetetracarboxylic dianhydride. 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, 1,4,5,8-tetrafluoronaphthalene-2,3,6,7-tetracarboxylic dianhydride, and phenanthrene-1,8,9,10-tetracarboxylic dianhydride.

16. The process of claim 15 wherein said aromatic sulfonyl diamine is 4,4′-diaminodiphenylsulfone (DDS) and said dianhydrides are pyromellitic dianhydride (PMDA) and 3,3′,4,4′-benzophenonetetracarboxylic dianhydride (BTDA).

17. The process of claim 10 wherein said copolyimide is soluble in a polar organic solvent with optional heating.

18. The copolyimide of claim 17 wherein said organic solvent is selected from the group consisting of m-cresol, N-methyl-2-pyrollidone (NMP), dimethyl sulfoxide (DMSO), N,N-dimethylacetamide (DMAc), and dimethylformamide (DMF).

19. The copolyimide of claim 10 wherein said copolyimide has a glass transition temperature of about 310° C. to about 350° C.
